(19) United States
(12) Patent Application Publication
(10) Pub. No.: US 2016/0163259 A1
(43) Pub. Date: Jun. 9, 2016

(54) PIXEL CIRCUIT AND DISPLAY APPARATUS

(71) Applicant: SAMSUNG DISPLAY CO., LTD., Yongin-si (KR)

(72) Inventors: Eiji Kanda, Yokohama (JP); Seiki Takahashi, Yokohama (JP); Takeshi Okuno, Yokohama (JP)

(21) Appl. No.: 14/952,774

(22) Filed: Nov. 25, 2015

(30) Foreign Application Priority Data
Dec. 8, 2014 (JP) 2014-247999

(51) Int. Cl. G09G 3/32

(52) U.S. Cl. CPC G09G 3/3233; G09G 2300/0426; G09G 2300/0819; G09G 2320/0276; G09G 2320/0626; G09G 2330/04

(57) ABSTRACT

A pixel circuit including a light emitting device configured to emit light in accordance with a current flowing thereto, a gradation control unit including a driving transistor configured to control light emission of the light emitting device, and a degradation compensating unit connected between the light emitting device and the gradation control unit and including a light receiving device, wherein a current flowing through the light receiving device varies according to the light emitted from the light emitting device, a compensating transistor configured to compensate for degradation of the light emitting device, wherein a gate electrode of the compensating transistor is connected to the light receiving device, and a compensating circuit configured to compensate for a threshold voltage of the compensating transistor.

### CROSS-REFERENCE TO RELATED APPLICATION

This application claims priority to and the benefit of Japanese Intellectual Property Office No. JP 2014-247999, filed on Dec. 8, 2014, the entire contents of which are hereby incorporated by reference.

### BACKGROUND

Aspects of embodiments of the present invention herein relate to a pixel circuit and a display apparatus.

For a pixel circuit including a light emitting device and a driving transistor controlling light emission of the light emitting device, a technique is being developed which compensates for degradation by changing a light emission period in accordance with the degradation of the light emitting device. For example, one technique for compensating for the degradation of the light emitting device is disclosed in Japanese Patent Application Laid-open Publication No. JP2003-509728A.

For example, a pixel circuit employing the technique disclosed in JP2003-509728A includes a light emitting device, a driving transistor for controlling light emission of the light emitting device, and a photodiode for receiving light emitted from the light emitting device. When the light emitting device is degraded, a light emission amount is decreased and accordingly a current amount flowing through the photodiode is reduced. As a result, for example, in a pixel circuit using the technique disclosed in JP2003-509728A, a driving transistor enables the light emitting device to emit light longer. In other words, for example, a pixel circuit using the technique disclosed in JP2003-509728A compensates for degradation of the light emitting device by making the light emission period longer by an amount corresponding to the degree that the light becomes dark according to a decrease in light emission amount of the light emitting device due to the degradation.

However, when the technique disclosed in JP2003-509728A is applied to a device (or circuit) including a plurality of pixel circuits, for example, a display apparatus including a pixel circuit in plural in a matrix type, there may be two limitations as the following:
When a threshold voltage of the driving transistor varies, the light emission period varies according to the varied threshold voltage.
Because a gate voltage of the driving transistor is changed by the photodiode, current flowing through the light emitting device varies at all times, which is a cause of light amount change of the light emitting device.

Accordingly, even though, for example, the technique disclosed in JP2003-509728A is used, the degradation of the light emitting device may not be sufficiently compensated.

### SUMMARY

Aspects of embodiments of the present invention are directed to a pixel circuit capable of compensating for degradation of a light emitting device included therein and a display apparatus.

An embodiment of the present invention provides a pixel circuit including : a light emitting device configured to emit light in accordance with a current flowing thereto; a gradation control unit including a driving transistor configured to control light emission of the light emitting device; and a degradation compensating unit connected between the light emitting device and the gradation control unit and including a light receiving device, wherein a current flowing through the light receiving device varies according to the light emitted from the light emitting device, a compensating transistor configured to compensate for degradation of the light emitting device, wherein a gate electrode of the compensating transistor is connected to the light receiving device, and a compensating circuit configured to compensate for a threshold voltage of the compensating transistor.

According to one aspect of embodiments of the present invention, an amount of current flowing to a light receiving device varies according to an amount of light emitted from the light emitting device, and accordingly a light emission period of a light emitting device is adjusted. In addition, according to this configuration, because a threshold voltage of a compensating transistor is compensated, a light emission period of the light emitting device does not rely on the threshold voltage of the compensating transistor. Accordingly, degradation of a light emitting device included the pixel circuit may be compensated by this configuration.

The degradation compensating unit may further include: a first transistor configured to connect the light emitting device and the compensating transistor in accordance with a first voltage applied to a gate electrode of the first transistor, wherein a first terminal of the first transistor is connected to the light emitting device, and a second terminal of the first transistor is connected to a first terminal of the compensating transistor; a second transistor configured to connect the compensating transistor and driving transistor in accordance with the first voltage applied to a gate electrode of the second transistor, wherein a first terminal of the second transistor is connected to a first terminal of the driving transistor, and a second terminal of the second transistor is connected to a first terminal of the driving transistor of the gradation control unit; and a third transistor having a first terminal connected to the gate electrode of the compensating transistor and a second terminal connected to an initialization voltage source, the third transistor being configured to connect the initialization voltage source to the gate electrode of the compensating transistor in accordance with a second voltage applied to a gate electrode of the third transistor.

The degradation compensating unit may further include: a fourth transistor configured to connect the compensating transistor and driving transistor in accordance with a first voltage applied to a gate electrode of the fourth transistor, wherein a first terminal of the fourth transistor is connected to a second terminal of the driving transistor of the gradation control unit, and a second terminal of the fourth transistor is connected to a first terminal of the driving transistor; a fifth transistor configured to connect a power source and the compensating transistor in accordance with the first voltage applied to a gate electrode of the fifth transistor, wherein a first terminal of the fifth transistor is connected to the second terminal of the compensating transistor and a second terminal of the fifth transistor is connected to the power source; and a sixth transistor having a first terminal connected to the gate electrode of the compensating transistor and a second terminal connected to an initialization voltage source, the sixth transistor being configured to connect the initialization voltage source to the gate electrode of the compensating transistor in accordance with a second voltage applied to the gate electrode of the sixth transistor.

The compensating circuit may include: a seventh transistor configured to connect a first terminal of the compensating transistor to the gate electrode of the compensating transistor on a basis of a third voltage applied to a gate electrode of the seventh transistor, wherein a first terminal of the seventh transistor is connected to the gate electrode of the compensating transistor and a second terminal of the seventh transistor is connected to the first terminal of the compensating transistor; and an eighth transistor having a first terminal connected to the second terminal of the compensating transistor and a second terminal connected to a compensation voltage source, the eighth transistor being configured to connect the compensation voltage source which supplies a compensation voltage corresponding to compensation data to the second terminal of the compensating transistor, wherein the compensating circuit is configured to apply the compensation voltage to the gate electrode of the compensating transistor through the eighth transistor, compensating transistor, and seventh transistor.

The light receiving device may be a photodiode or a phototransistor.

In an embodiment of the present invention, a display apparatus includes: a display unit including a plurality of pixel circuits in a matrix form, the display unit being configured to display an image based on supplied display data, wherein each of the pixel circuits includes: a light emitting device configured to emit light in accordance with a current flowing thereto; a gradation control unit including a driving transistor configured to control light emission of the light emitting device; and a degradation compensating unit connected between the light emitting device and the gradation control unit and including a light receiving device, wherein a current flowing through the light receiving device varies according to the light emitted from the light emitting device, a compensating transistor configured to compensate for degradation of the light emitting device, wherein a gate electrode of the compensating transistor is connected to the light receiving device, and a compensating circuit configured to compensate for a threshold voltage of the compensating transistor.

According to one aspect of embodiments of the present invention, in each pixel circuit, for example, an amount of current flowing to a light receiving device varies according to an amount of light emitted from the light emitting device, and accordingly a light emission period of a light emitting device is adjusted. In addition, according to this configuration, in each circuit, because a threshold voltage of a compensating transistor is compensated, a light emission period of the light emitting device does not rely on the threshold voltage of the compensating transistor. Accordingly, degradation of a light emitting device of the pixel circuit may be compensated by this configuration.

### BRIEF DESCRIPTION OF THE FIGURES

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a diagram illustrating a configuration of a pixel circuit according to an embodiment of the present invention;

FIG. 2 is a timing chart illustrating an operation of a pixel circuit according to an embodiment of the present invention;

FIG. 3A is a diagram illustrating an exemplary operation of a pixel circuit according to an embodiment of the present invention;

FIG. 3B is a diagram illustrating an exemplary operation of a pixel circuit according to an embodiment of the present invention; and

FIG. 3C is a diagram illustrating an exemplary operation of a pixel circuit according to an embodiment of the present invention.

### DETAILED DESCRIPTION

Exemplary embodiments of the present invention will be described below in more detail with reference to the accompanying drawings. Throughout the specification and drawings, like reference numerals refer to elements having substantially like functional configurations to omit overlapping description.

Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly elements that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated.

It will be understood that, although the terms “first,” “second,” “third,” etc., may be used herein to describe various elements, components, and/or sections, these elements, components, and/or sections should not be limited by these terms. These terms are used to distinguish one element, component or section from another element, component, or section. Thus, a first element, component, or section described below could be termed a second element, component, or section, without departing from the spirit and scope of the present invention.

It will be understood that when an element is referred to as being “on,” “connected to,” or “coupled to” another element, it can be directly on, connected to, or coupled to the other element, or one or more intervening elements may be present. In addition, it will also be understood that when an element is referred to as being “between” two elements, it can be the only element between the two elements, or one or more intervening elements may also be present.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

The use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

The electronic or electric devices and/or any other relevant devices or components according to embodiments of the present invention described herein may be implemented utilizing any suitable hardware, firmware (e.g., an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

(Pixel Circuit According to an Embodiment of the Present Invention)

[1] Configuration of a Pixel Circuit According to an Embodiment of the Present Invention

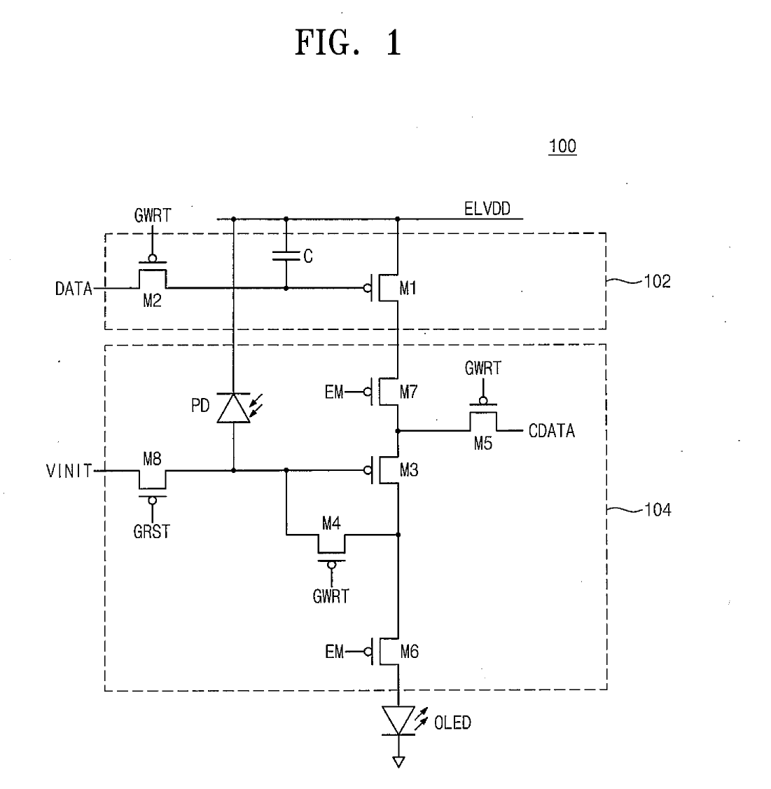

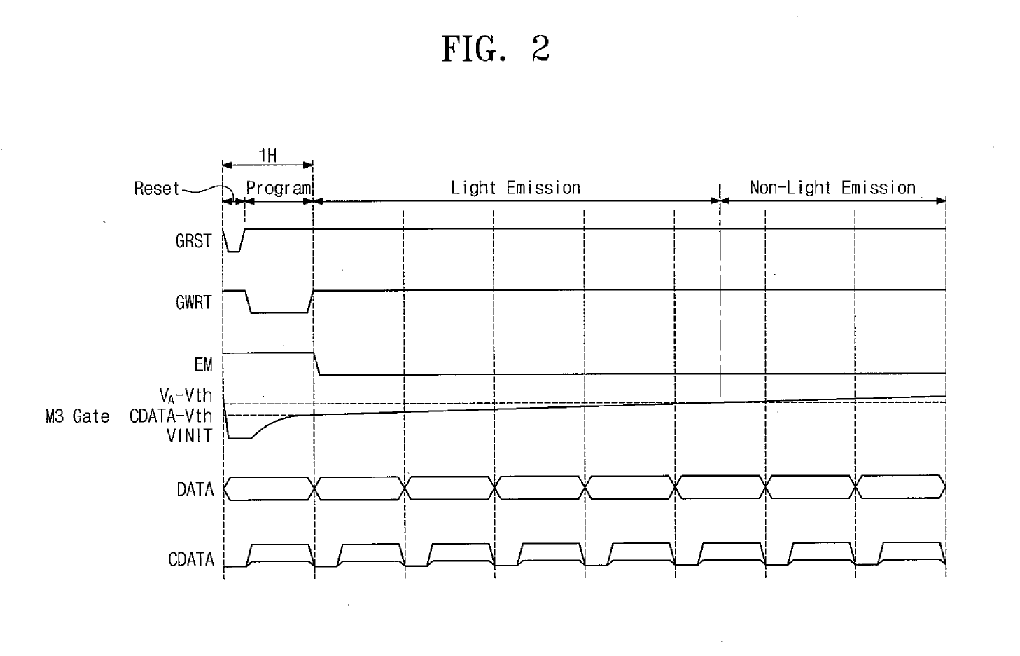

FIG. 1 is a diagram illustrating a configuration of a pixel circuit 100 according to an embodiment of the present invention. In addition, FIG. 2 is a timing chart illustrating an operation of a pixel circuit 100 according to an embodiment of the present invention.

The pixel circuit 100 includes a light emitting device OLED, a gradation control unit 102, and a degradation compensating unit 104.

In addition, the pixel circuit 100 is connected to a plurality of signal lines through which a signal GRST (or second voltage), a signal GWRT (or third and fourth voltages), a signal EM (or first voltage), a signal DATA (or voltage corresponding to display data), and a signal CDATA (or compensation voltage corresponding to compensation data) are respectively supplied. Supplies of various signals to respective signal lines are provided from, for example, a driver included in a display apparatus,' which is to be described in more detail below, including a display unit having the pixel circuit 100, or a driver outside the pixel circuit 100 such as a driver included in a device outside the pixel circuit 100.

[1-1] Light Emitting Device OLED

The light emitting device OLED emits light in accordance with a current flowing thereto. The light emitting device OLED may be an arbitrary (e.g., any) light emitting device which emits light in accordance with a current flowing thereto, for example, an organic electroluminescence (EL) device, an inorganic electroluminescence device, or the like. Hereinafter, an organic EL device is exemplified as the light emitting device according to an embodiment of the present invention.

[1-2] Gradation Control Unit 102

The gradation control unit 102 controls light emission of the light emitting device OLED. The gradation control unit 102 controls the light emission of the light emitting device OLED by controlling the current flowing to the light emitting device

OLED as a current corresponding to the signal DATA in accordance with (e.g., on the basis of) the signal DATA supplied through a signal line.

The gradation control unit 102 includes, for example, a driving transistor M1, a switch transistor M2, and a capacitor C.

Here, as a transistor according to an embodiment of the present invention, there is, for example, a thin film transistor TF or a field effect transistor (FET) such as a metal-oxide-semiconductor field effect transistor (MOSFET) or the like. In FIG. 1, a transistor according to an embodiment of the present invention is illustrated as a P-channel type TFT, but embodiments of the present invention are not limited thereto. For example, a transistor according to an embodiment of the present invention may be an N-channel type. In addition, in a pixel circuit according to an embodiment of the present invention, for example, a P-channel type transistor and N-channel type transistor may be mixed-used. In addition, a transistor according to an embodiment of the present invention may be an arbitrary (e.g., any) kind of transistor such as an amorphous silicon transistor or low-temperature polysilicon transistor, or oxide transistor, which is capable of performing a role of each transistor to be described below. In addition, when capable of performing the role of each transistor, a transistor according to an embodiment of the present invention may be any such suitable circuit device.

Hereinafter, a P-channel type TFT is exemplified as a transistor according to an embodiment of the present invention. In addition, hereinafter, an embodiment where a first terminal is a drain and a second terminal is a source in the transistor is described according to the embodiment of the present invention. In a pixel circuit according to other embodiments of the present invention, there may be a case where a first terminal is a source and a second terminal is a drain according to an embodiment of the present invention according to a supplied power source voltage or a circuit configuration.

The driving transistor M1 performs a role of controlling light emission of the light emitting device OLED. A first terminal of the driving transistor M1 is connected to the degradation compensating unit 104 and a second terminal is connected to a power source for supplying a voltage ELVDD. In addition, a gate terminal (e.g., control terminal) of the driving transistor M1 is connected to a first terminal of the switch transistor M2 and the capacitor C.

The switch transistor M2 is selectively turned on or off in accordance with (e.g., on the basis of) a voltage according to the signal GWRT supplied to the gate terminal. The first terminal of the switch transistor M2 is connected to the gate (or gate electrode) of the driving transistor M1 and one terminal of the capacitor C, and a second terminal of the switch transistor M2 is connected to a signal line through which the signal DATA is supplied. A voltage according to the signal DATA is maintained in the capacitor C by a turn-on of the switch transistor M2.

One end of the capacitor is connected to the gate terminal of the driving transistor M1 and the other end is connected to the power source. The capacitor C performs a role of maintaining a potential of the gate (or gate electrode) of the driving transistor M1. The pixel circuit may include the capacitor C to maintain the data (e.g., display data) corresponding to the signal DATA.

The capacitor C may be, for example, a capacitive device having a capacitance (e.g., a predetermined capacitance). In addition, the pixel circuit may also employ the capacitor C as parasitic capacitance.

The gradation control unit 102 includes, for example, a configuration shown in FIG. 1 to control light emission of the light emitting device OLED in accordance with (e.g., on the basis of) the signal DATA supplied through the signal line.

In addition, a configuration of the gradation control unit included in a pixel circuit according to an embodiment of the present invention is not limited to the configuration illustrated in FIG. 1. For example, a pixel circuit according to an embodiment of the present invention may have other configurations that include a driving transistor M1 and that is capable of controlling current flowing to the light emitting device OLED in accordance with (e.g., on the basis of) the signal DATA supplied through the signal line, such as a configuration that further includes a compensating circuit for compensating for a threshold voltage of the driving transistor M1.

[1-3] Degradation Compensating Unit 104

The degradation compensating unit 104 includes, for example, a light receiving device PD, a compensating transistor M3, and a compensating circuit for compensating for a threshold voltage of the compensating transistor M3 and for degradation of the light emitting device OLED. The degradation compensating unit 104 compensates for the degradation of the light emitting device OLED by adjusting a light emission period of the light emitting device OLED with current flowing to the light receiving device PD according to the light emitted from the light emitting device OLED.

The degradation compensating unit 104 includes, for example, as illustrated in FIG. 1, a light receiving device PD, a compensating transistor M3, a compensating circuit including a transistor M4 (or seventh transistor), and a transistor M5 (or eighth transistor), a transistor M6 (or first transistor), a transistor M7 (or second transistor), and a transistor M8 (or third transistor).

The light receiving device PD includes one terminal connected to the power source for supplying the voltage ELVDD and the other terminal connected to a gate (or gate electrode) of the compensating transistor M3. The current flows through the light receiving device PD according to the light emitted from the light emitting device OLED.

As the light receiving device PD, there is, for example, a photodiode or a phototransistor. In addition, the light receiving device PD may be suitable device through which current flows in accordance with the light emitted from the light emitting device OLED.

The compensating transistor M3 performs a role of compensating for the degradation of the light emitting device OLED. A first terminal of the compensating transistor M3 is connected to a second terminal of the transistor M4 and a second terminal of the transistor M6, and a second terminal of the compensating transistor M3 is connected to a first terminal of the transistor M5 and a first terminal of the transistor M7. In addition, a gate of the compensating transistor M3 is connected to the other terminal of the light receiving device PD, a first terminal of the transistor M4, and a first terminal of the transistor M8.

The transistor M4 is a transistor configuring the compensating circuit. The first terminal of the transistor M4 is connected to the gate of the compensating transistor M3, and the second terminal of the transistor M4 is connected to the first terminal of the compensating transistor M3. In addition, the transistor M4 is selectively turned on or off in accordance with (e.g., on the basis of), for example, a voltage (or third voltage) according to the signal GWRT applied to the gate thereof. When the transistor M4 is turned on, the compensating transistor M3 is diode-connected.

The transistor M5 is another transistor configuring the compensating circuit. A first terminal of the transistor M5 is connected to the second terminal of the compensating transistor M3, and the second terminal of the transistor M5 is connected to the signal line through which a voltage according to the signal CDATA is supplied. In addition, the transistor M5 is selectively turned on or off in accordance with (e.g., on the basis of), for example, a voltage (or fourth voltage) according to the signal GWRT applied to the gate thereof.

Here, the voltage according to the signal CDATA is a compensation voltage corresponding to the compensation data. The compensation data according to an embodiment of the present invention is, for example, data having one-to-one correspondence to the display data. In other words, the compensation voltage according an embodiment of the present invention is a voltage variable in correspondence to the display data.

The compensating circuit includes, for example, the transistor M4 and transistor M5 as described above. In the degradation compensating unit 104 with the compensating circuit, a voltage (or compensation voltage) according to the signal CDATA is applied to the gate of the transistor M3 through the transistor M5, compensating transistor M3, and transistor M4 in order to compensate for the threshold value of the compensating transistor M3. The compensation for the threshold value of the compensating transistor M3 with the compensating circuit will be described in more detail later.

In addition, even though FIG. 1 exemplarily illustrates that the signal GWRT is applied to the gates of the transistors M5 and M6, a signal applied to the gates of the transistors M5 and M6 is not limited thereto. For example, a signal applied to the gates of the transistors M5 and M4 may be another signal for generating a period in which the transistors M4 and M5 are turned on together.

The transistor M6 performs a role of selectively connecting the light emitting device to the degradation compensating unit 104. The first terminal of the transistor M6 is connected to, for example, an anode of the light emitting device OLED, and the second terminal of the transistor M6 is connected to the first terminal of the compensating transistor M3. The transistor M6 is selectively turned on or off in accordance with (e.g., on the basis of) a voltage (or first voltage) according to a signal EM applied to the gate thereof to connect the light emitting device OLED and the degradation compensating unit 104.

The transistor M7 performs a role of selectively connecting the compensating transistor M3 and the driving transistor M1 included in the gradation control unit 102. The first terminal of the transistor M7 is connected to the second terminal of the compensating transistor M3, and the second terminal of the transistor M7 is connected to the first terminal of the driving transistor M1. The transistor M7 is selectively turned on or off in accordance with (e.g., on the basis of) a voltage (or first voltage) according to the signal EM applied to the gate thereof to connect the compensating transistor M3 and the driving transistor M1.

The transistor M8 performs a role of resetting (or initializing) the gate of the compensating transistor M3. The first terminal of the transistor M8 is connected to the gate of the compensating transistor M3, and the second terminal of the transistor M8 is connected to the signal line through which a voltage (or initialization voltage) according to the signal VINIT is supplied. In addition, the transistor M8 is selectively turned on or off in accordance with (e.g., on the basis of) a voltage (or second voltage) according to the signal GRST applied to the gate thereof. When the transistor M8 is turned on, the gate of the compensating transistor M3 is initialized.

The degradation compensating unit 104 with, for example, the configuration illustrated in FIG. 1, compensates for the degradation of the light emitting device OLED and also compensates for the threshold value of the compensating transistor M3. An exemplary operation of the degradation compensating unit 104 illustrated in FIG. 1 will be described in more detail later.

In addition, the configuration of the gradation control unit included in the pixel circuit according to an embodiment of the present invention is not limited to the configuration illustrated in FIG. 1.

For example, when the pixel circuit 100 according to an embodiment of the present invention is configured to be electrically cut off from one or both of the gradation control unit 102 and the light emitting device OLED at the time when the degradation compensating unit 104 operates to compensate for the degradation of the light emitting device OLED, the degradation compensating unit may be configured not to have (e.g., without) one or both of the transistors M6 and M7. In addition, for example, when the supply of the signal VINIT is controlled by an external driver, the degradation compensating unit may be configured not to include the transistor M8 (e.g., to exclude the transistor M8).

The pixel circuit 100 according to an embodiment of the present invention has, for example, a configuration illustrated in FIG. 1.

In addition, the configuration of the pixel circuit according to an embodiment of the present invention is not limited to the configuration illustrated in FIG. 1.

For example, even though in FIG. 1, the degradation compensating unit 104 has a configuration that the degradation compensating unit 104 is connected between the gradation control unit 102 and the light emitting device OLED, the pixel circuit according to an embodiment of the present invention may also have a configuration that the gradation control unit 102 is connected between the degradation compensating unit 104 and the light emitting device OLED.

Similarly to, for example, the degradation compensating unit 104 as illustrated in FIG. 1, the degradation compensating unit 104 configuring the pixel circuit according to the forgoing modified example embodiment, includes a light receiving device PD, a compensating transistor M3, a compensating circuit including a transistor M4 (or seventh transistor), and a transistor M5 (or eighth transistor), a transistor M6 (or fourth transistor), a transistor M7 (or fifth transistor), and a transistor M8 (or sixth transistor). In the degradation compensating unit 104 configuring the pixel circuit according to the modified example embodiment, a connection relationship between the transistors M6 and M7 is different from that of the transistors M6 and M7 illustrated in FIG. 1.

In more detail, a first terminal of the transistor M6 according to the modified example embodiment is connected to a second terminal of the driving transistor M1 included in the gradation control unit 102, and a second terminal of the transistor M6 according to the modified example embodiment is connected to a first terminal of the compensating transistor M3. In addition, the transistor M6 according to the modified example embodiment is selectively turned on or off in accordance with (e.g., on the basis of) a voltage (or first voltage) according to the signal EM applied to a gate thereof to connect the compensating transistor M3 and the driving transistor M1.

In addition, a first terminal of the transistor M7 according to the modified example embodiment is connected to a second terminal of the compensating transistor M3, and a second terminal of the transistor M7 according to the modified example embodiment is connected to the power source for supplying the voltage ELVDD. In addition, the transistor M7 according to the modified example embodiment is selectively turned on or off in accordance with (e.g., on the basis of) a voltage (or first voltage) according to the signal EM applied to a gate thereof to connect the power source and the compensating transistor M3.

In the pixel circuit according to the modified example embodiment, connection relationships between the gradation control unit 102, the degradation compensating unit 104, and the light emitting device OLED are different from those in the pixel circuit 100 illustrated in FIG. 1, but each configuration and function of the gradation control unit 102, degradation compensating unit 104, and light emitting device OLED according to the modified example embodiment are identical to those of the gradation control unit 102, degradation compensating unit 104, and light emitting device OLED included in the pixel circuit 100. Accordingly, the pixel circuit according to the modified example embodiment may operate similarly to the pixel circuit 100 and exhibit a substantially similar effect (e.g., an identical effect) to that of the pixel circuit 100.

[2] Operation of a Pixel Circuit According to an Embodiment of the Present Invention

Next, an exemplary operation of the pixel circuit according to an embodiment of the present invention will be described. Hereinafter, a description is provided about an operation of the pixel circuit according to the embodiment of the present invention by describing a case where the pixel circuit illustrated in FIG. 1 operates in accordance with (e.g., on the basis of) the timing chart illustrated in FIG. 2. In addition, because the operation of the pixel circuit according to the foregoing modified example embodiment is substantially the same as that of a pixel circuit 100 to be described in more detail later, a description thereof will be omitted.

[2-1] Operation in a Reset Period (“Reset” Illustrated in FIG. 2)

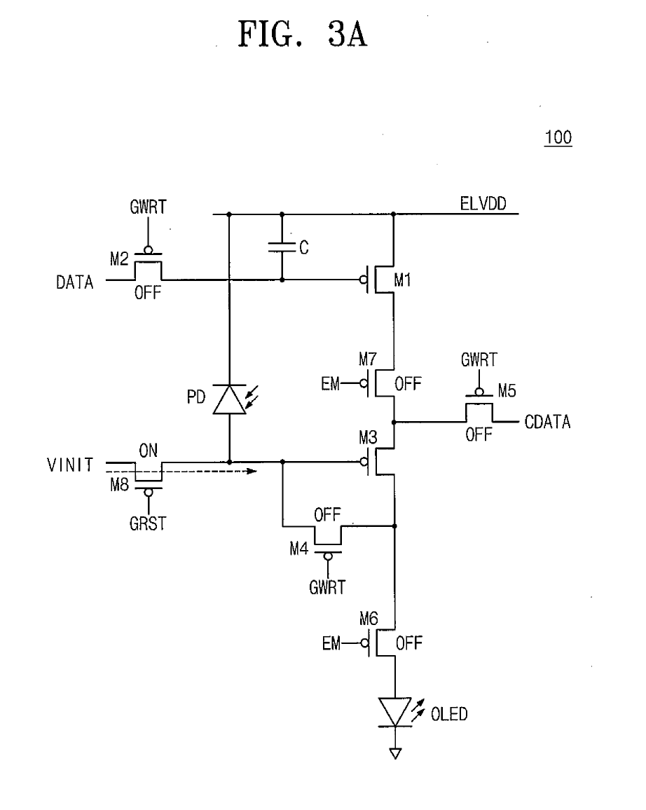

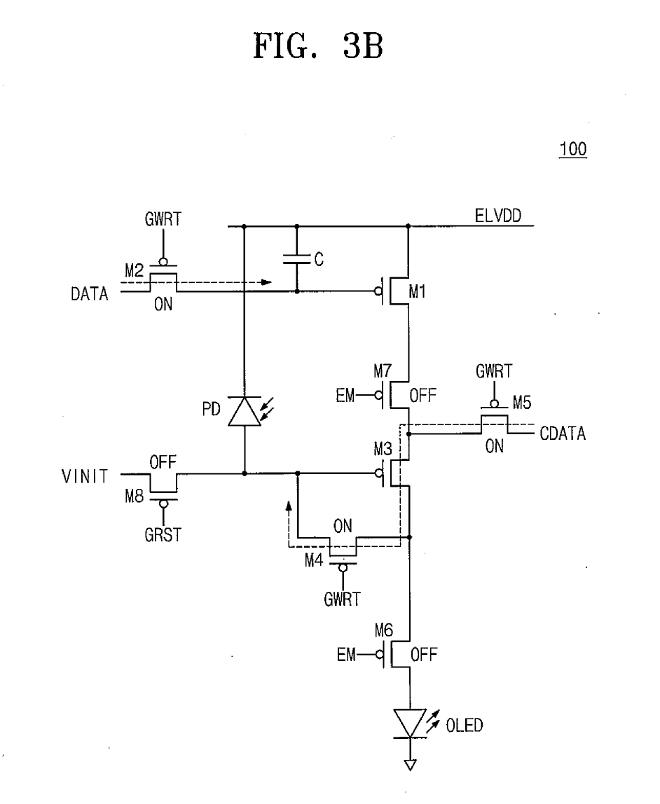

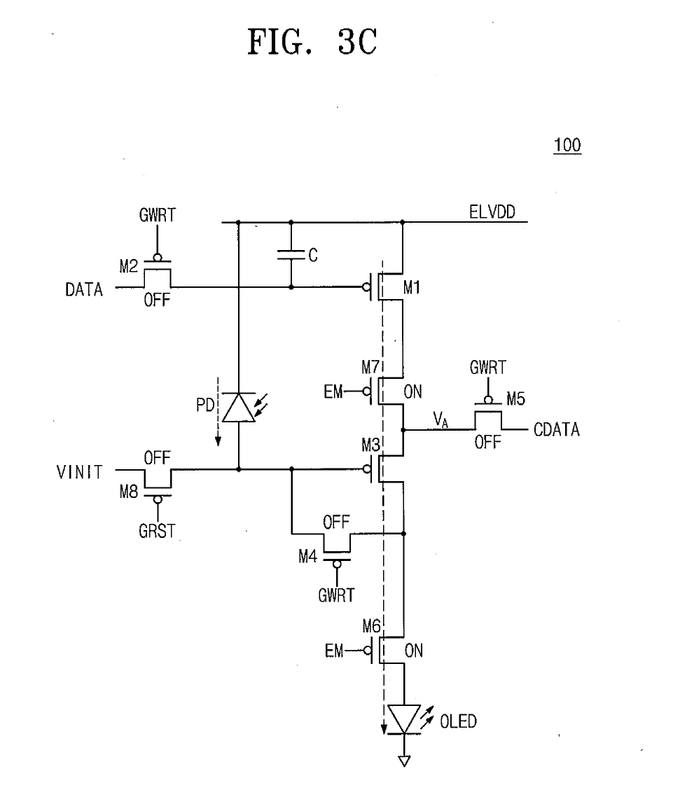

FIG. 3A is a diagram for explaining an example of an operation of the pixel circuit 100 according to an embodiment of the present invention, and illustrates an operation of the pixel circuit 100 during a “Reset” period as illustrated in FIG. 2.

During the reset period, the transistor M8 is turned on by the signal GRST and other transistors are respectively turned off by corresponding signals. Accordingly, in the reset period, the gate signal of the compensating transistor M3 is reset by the voltage (or initialization voltage) according to the signal VINIT.

[2-2] Operation in a Program Period (“Program” Illustrated in FIG. 2)

FIG. 3B is a diagram for explaining an example of an operation of the pixel circuit 100 according to an embodiment of the present invention, and illustrates an operation of the pixel circuit 100 during a “Program” period as illustrated in FIG. 2.

In the program period, the transistor M2, the transistor M4, and the transistor M5 are turned on by the signal GWRT and other transistors are respectively turned off by corresponding signals.

Due to a turn-on of the transistor M2, the display data (or gradation data) for the gate (or gate electrode) of the driving transistor M1 is programmed. In more detail, in the pixel circuit 100, the transistor M2 is turned on by the signal GWRT and a voltage according to the signal DATA corresponding to the display data is maintained by the capacitance of the capacitor C to allow the display data to be programmed.

In addition, the transistor M4 and transistor M5 configuring the compensating circuit are turned on, the threshold value of the degradation compensating transistor M3 is compensated in the program period.

In the pixel circuit 100, a voltage (or compensation voltage) according to the signal CDATA is applied to the gate of the compensating transistor M3 through the transistor M5, the compensating transistor M3, and the transistor M4. At this point, the gate voltage Vg (M3) of the transistor M3 becomes a voltage relying on the threshold voltage Vₜₕ of the compensating transistor M3, for example, as shown in Equation (1). Here, “CDATA” shown in the following Equation (1) is a compensation voltage and is a voltage set corresponding to the display data as described above (identical in other Equations). In addition, in the pixel circuit 100 illustrated in FIG. 1, because the compensating transistor M3 is a P-channel transistor, the threshold voltage Vₜₕ has a negative value.

V_{g}(M3)=CDATA+Vₜₕ (1)

[2-3] Operation in the light emission period and in a non-light emission (“light emission” and “non-light emission” shown in FIG. 2)

FIG. 3C is a diagram for explaining an example of an operation of the pixel circuit 100 according to an embodiment of the present invention, and illustrates an operation of the pixel circuit 100 during the “light emission” and “non-light emission” periods illustrated in FIG. 2.

In the light emission period and non-light emission period, the transistor M6 and the transistor M7 are turned on by, for example, the signal EM and other transistors are respectively turned off by corresponding signals.

As the transistor M6 and the transistor M7 are turned on, current in accordance with a voltage, which corresponds to the display data that is applied to the gate of the driving transistor M1, flows to the light emitting device OLED and the light emitting device OLED emits light according to an amount (e.g., a magnitude) of the current.

The light emitted from the light emitting device OLED is received by the light receiving device PD, and the light receiving device PD continuously outputs current according to an amount of the light emitted from the light emitting device OLED. As the light receiving device PD outputs the current according to the amount of light emitted from the light emitting device OLED, the gate voltage V_{g}(M3) of the compensating transistor M3 continuously increases as shown in the following Equation (2).

Here, “C” shown in Equation (2) is, for example, the parasitic capacitance of the light receiving device PD or the driving transistor M1. In addition, “C” shown in Equation (2) may be a capacitive device such as a capacitor. “C” shown in Equation (2) may be adjustable by, for example, the size of the light emitting device PD or the driving transistor M1, the size of the capacitive device, or the like.

In addition, “I” shown in Equation (2) is the current flowing through the light receiving device PD. “I” shown in Equation (2) is adjustable by, for example, the size of the light receiving device PD.

In addition, “t” shown in Equation (2) is a time (for example, a time in units of seconds, hereinafter, ‘light emission stop time’) from when the light emitting device OLED starts to emit the light until the light emitting device OLED stops the light emission.

$${V}_{g} ( M 3 ) = CDATA + {V}_{th} + \frac{I \cdot t}{C} \qquad ( 2 )$$

A gate voltage V_{g}(M3) of the compensating transistor M3 continuously increases according to Equation (2), and the compensating transistor M3 is turned off at the time shown in Equation (3). In addition, as the compensating transistor M3 is turned off, the light emission by the light emitting device OLED is stopped in the pixel circuit 100.

Here, “V_{A}” shown in Equation (3) is a voltage (e.g., source voltage) at the second terminal of the compensating transistor M3, which is determined by gradation represented with the display data.

$${V}_{A} + {V}_{th} = CDATA + {V}_{th} + \frac{I \cdot t}{C} \qquad ( 3 )$$

From Equation (3), the light emission stop time when the light emitting device OLED in which the compensating transistor M3 is turned off stops the light emission may be expressed with the following Equation (4).

$$t = \frac{C}{I} ( {V}_{A} - CDATA ) \qquad ( 4 )$$

It may be seen that from Equation (4), when the current “I” flowing through the light receiving device PD decreases (or becomes lesser), the light emission stop time increases (or becomes longer). In other words, when the light emission device OLED included in the pixel circuit 100 degrades and the amount of light emitted from the light emitting device OLED is decreased, the current amount flowing to the light emitting device PD decreases to make the light emission stop time longer and as a result, the light emission period becomes longer.

Accordingly, in the pixel circuit 100, an extension of the light emission period enables compensation for the decrease in light emission amount by the degradation of the light emitting device OLED.

In addition, it may be seen from Equation (4) that the light emission period of the light emitting device OLED does not rely on the threshold voltage Vₜₕ of the compensating transistor M3. Accordingly, even though there is a change in the threshold voltage Vₜₕ of the compensating transistor M3 included in each of a plurality of pixel circuits 100, the change in the corresponding threshold voltage Vₜₕ does not influence the light emission period.

In addition, the light emission time “t” depends on “C”, “I”, and “CDATA” as shown in Equation (4). Here, as described above, “C” is adjustable by the size of the light emitting device PD or the driving transistor M1, the size of a capacitance device, or the like, and “I” is adjustable by, for example, the size of the light receiving device PD. In addition, as described above, “CDATA” is a compensation voltage correspondingly set to the display data. Accordingly, the light emission stop time “t’ may be a design parameter adjustable by a designer of the pixel circuit 100 (or a display apparatus to be described in more detail later according to an embodiment of the present invention).

Accordingly, the pixel circuit 100 may compensate for degradation of the light emitting device OLED included in the pixel circuit 100.

(Display Apparatus According to an Embodiment of the Present Invention)

A display circuit according to an embodiment of the present invention may be included in a display apparatus on which an image represented by image data may be displayed on a screen. The display apparatus according to an embodiment of the present invention is a display unit for displaying an image in accordance with (e.g., on the basis of) the supplied display data, and includes a plurality of pixel circuits according to an embodiment of the present invention in a matrix form.

In addition, in the display apparatus according to an embodiment of the present invention, for example, each of the plurality of pixel circuits configuring the display unit includes one or 2 or more drivers supplying each signal as illustrated in FIG. 2. In addition, the display apparatus according to an embodiment of the present invention may include a timing controller for controlling, for example, process timings of the one or two or more drivers. In addition, the one or two or more drivers or the timing controller may be an external device of the display apparatus according to an embodiment of the present invention.

In the display unit included in the display apparatus according to an embodiment of the present invention, the operations described in relation to, for example, FIGS. 2, 3A, and 3B, are performed in each of the pixel circuits configuring the display unit.

Accordingly, in the display apparatus according to an embodiment of the present invention, because the degradation of the light emitting device OLED is compensated in each of the pixel circuits configuring the display unit, image sticking (or burn-in) is restricted (or reduced).

In addition, because the image sticking is restricted, the display apparatus according to an embodiment of the present invention may improve display quality of a pixel, which displays an image on a screen of the display unit or improve life of the display apparatus according to an embodiment of the present invention.

In addition, in each of the pixel circuits configuring the display unit included in the display apparatus according to an embodiment of the present invention, as illustrated in FIG. 1, the gate voltage of the driving transistor M1 is not varied by the light emitting device PD. In other words, in the display apparatus according to an embodiment of the present invention, it is not that the current flowing to the light emitting device OLED changes in accordance with the gate voltage of the driving transistor M1 is varied by the light receiving device PD as would be the case in the technique disclosed in JP2003-509728A.

Accordingly, in the display apparatus according to an embodiment of the present invention, the light amount from the light emitting device OLED is not changed by varying the gate voltage of the driving transistor M1 using variation in the light emitting device PD. Accordingly, a change (or variations) in light emission may be further restricted or reduced when compared to a display apparatus using the technique disclosed in JP2003-509728A.

In the foregoing description, although a display apparatus is exemplified as an apparatus including the pixel circuit according to an embodiment of the present invention, the apparatus including the pixel circuit according to an embodiment of the present invention is not limited thereto. The pixel circuit according to an embodiment of the present invention may be applied to various devices having a function of displaying an image, which includes a TV, a communication device such as tablet type device, mobile phone, image/video playing device (or image/music recording playback device), game player, or computer such as a PC.

According to an embodiment of the present invention, degradation of the light emitting device included in the pixel circuit may be compensated.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A pixel circuit comprising:
a light emitting device configured to emit light in accordance with a current flowing thereto;
a gradation control unit comprising a driving transistor configured to control light emission of the light emitting device; and
a degradation compensating unit connected between the light emitting device and the gradation control unit and comprising:
a light receiving device, wherein a current flowing through the light receiving device varies according to the light emitted from the light emitting device;
a compensating transistor configured to compensate for degradation of the light emitting device, wherein a gate electrode of the compensating transistor is connected to the light receiving device; and
a compensating circuit configured to compensate for a threshold voltage of the compensating transistor.

2. The pixel circuit of claim 1, wherein the degradation compensating unit further comprises:
a first transistor configured to connect the light emitting device and the compensating transistor in accordance with a first voltage applied to a gate electrode of the first transistor, wherein a first terminal of the first transistor is connected to the light emitting device and a second terminal of the first transistor is connected to a first terminal of the compensating transistor;
a second transistor configured to connect the compensating transistor and driving transistor in accordance with the first voltage applied to a gate electrode of the second transistor, wherein a first terminal of the second transistor is connected to a first terminal of the driving transistor and a second terminal of the second transistor is connected to a first terminal of the driving transistor of the gradation control unit; and
a third transistor having a first terminal connected to the gate electrode of the compensating transistor and a second terminal connected to an initialization voltage source, the third transistor being configured to connect the initialization voltage source to the gate electrode of the compensating transistor in accordance a second voltage applied to a gate electrode of the third transistor.

3. The pixel circuit of claim 1, wherein the degradation compensating unit further comprises:
a fourth transistor configured to connect the compensating transistor and driving transistor in accordance with a first voltage applied to a gate electrode of the fourth transistor, wherein a first terminal of the fourth transistor is connected to a second terminal of the driving transistor of the gradation control unit, and a second terminal of the fourth transistor is connected to a first terminal of the driving transistor;
a fifth transistor configured to connect a power source and the compensating transistor in accordance with the first voltage applied to a gate electrode of the fifth transistor, wherein a first terminal of the fifth transistor is connected to the second terminal of the compensating transistor and a second terminal of the fifth transistor is connected to the power source; and
a sixth transistor having a first terminal connected to the gate electrode of the compensating transistor and a second terminal connected to an initialization voltage source, the sixth transistor being configured to connect the initialization voltage source to the gate electrode of the compensating transistor in accordance with a second voltage applied to the gate electrode of the sixth transistor.

4. The pixel circuit of claim 1, wherein the compensating circuit comprises:
a seventh transistor configured to connect a first terminal of the compensating transistor to the gate electrode of the compensating transistor in accordance with a third voltage applied to a gate electrode of the seventh transistor, wherein a first terminal of the seventh transistor is connected to the gate electrode of the compensating transistor and a second terminal of the seventh transistor is connected to the first terminal of the compensating transistor; and
an eighth transistor having a first terminal connected to the second terminal of the compensating transistor and a second terminal connected to a compensation voltage source, the eighth transistor being configured to connect the compensation voltage source which supplies a compensation voltage corresponding to compensation data to the second terminal of the compensating transistor,
wherein the compensating circuit is configured to apply the compensation voltage to the gate electrode of the compensating transistor through the eighth transistor, compensating transistor, and seventh transistor.

5. The pixel circuit of claim 1, wherein the light receiving device is a photodiode or a phototransistor.

6. A display apparatus comprising:
a display unit comprising a plurality of pixel circuits in a matrix form, the display unit being configured to display an image based on supplied display data, each of the pixel circuits comprising:
a light emitting device configured to emit light in accordance with a current flowing thereto;
a gradation control unit comprising a driving transistor configured to control light emission of the light emitting device; and
a degradation compensating unit connected between the light emitting device and the gradation control unit and comprising:
a light receiving device, wherein a current flowing through the light receiving device varies according to the light emitted from the light emitting device;
a compensating transistor configured to compensate for degradation of the light emitting device, wherein a gate electrode of the compensating transistor is connected to the light receiving device; and
a compensating circuit configured to compensate for a threshold voltage of the compensating transistor.
